(19) United States
(12) Patent Application Publication
(10) Pub. No.: US 2008/0071737 A1
(43) Pub. Date: Mar. 20, 2008

(54) Method for retrieving searched results

(76) Inventor: Frank John Williams, Los Alamitos, CA (US)

Correspondence Address: Frank John Williams, 2711 Saint Albans dr, Los Alamitos, CA, 90720, US

(21) Appl. No.: 11/497,073

(22) Filed: Aug. 1, 2006

Related U.S. Application Data
(60) Provisional application No. 60/704,815, filed on Aug. 1, 2005.

(51) Int. Cl. G06F 17/30

(52) U.S. Cl. 707/3; 707/E17.108

(57) ABSTRACT

A method and system for retrieving information from a query within a website. In one embodiment, a first search engine or program of such first engine is used to visit al website, wherein a search engine of the website is used to produce a search of a database within the sites systems, thus producing an answer to the query that the first search engine/program uses to search another database.

RELATED APPLICATIONS

This is application claims the benefit of: provisional patent application Ser. No. 60/704,815, filed 2005 Aug. 1, and provisional patent application Ser. No. 60/764,931 filed 2006 Feb. 3, by the present inventor.

### BACKGROUND

1. Field of the Invention

The present invention relates generally to search of information in general. More specifically, a novel method for retrieving additional information occurred from an antecedent search result.

2. Description of Related Art

Revolutions of the Internet, new digital communications, and new digital documentations have ignited the evolution of the search engine into a myriad of technologies and methodologies. In particular, is the group of search engines used to find data in the immense information resources provided by the World Wide Web. Clients utilize these search engines to find answers to their different and vast queries.

Although search engines are capable of quickly offering the results generated from an initial query of a client; it is indeed true that many times is up to the client to go into each and every generated result independently in order to find more detailed information.

For example, a client enters in the query field of an Internet search engine the text “dogs”. Immediately, the search engine finds matching results in its database of website descriptions and then displays the links of such site. In the particular sample, the sites containing the text “dogs” (and/or hopefully the meaning of “dogs.”) will show up. It is then up to the client to click every link to find further more detailing information, such as the “normal body temperature” of the animal in discussion. Noteworthy, if the client would have started the search with the phrase “normal body temperature of dogs” the search engine would have produced only those sites wherein the corporal tempura of canines is mentioned. The problem is that many sites dedicated themselves to many topics and not just the temperature of dogs' bodies. As a consequence, the client acknowledging such a compromise reverses and/or broadens the query to “dogs”. The result of such a query proves to be extensively large and then the client visits each site independently implementing many exhausting hours of research and possible frustration. Consequentially, the clients limit their further searching and site visiting to only a few records or pages, thus eliminating the possibility of finding the intended detailed information.

In the intent of the search engines to help clients find internal information, the search engines offer the service to websites to contain all of their files and pages for a paying fee. In such fashion, the information contained within each site can also be searched directly from the initial prospective query of “dog's body temperature.” Unfortunately, this requires a financial incentive to the search company; it also requires the website to be subscribed with the particular search engine, and foremost requires that the website content be released procuring for future and possible updates. As a consequence, only a small percentage of websites implement this method. Furthermore, the client is unaware of which website is subscribed in the search engine inviting for a myriad of incomplete and long detail searches.

In view of the present shortcomings of using a single search to find detailed information, the present invention distinguishes over the prior art by providing heretofore a more compelling method to search for information providing in addition more unknown, unsolved and unrecognized advantages as described in the following summary

### SUMMARY OF THE INVENTION

The present invention teaches certain benefits in use and construction which give rise to the objectives and advantages described below. The method and system embodied by the present invention overcomes the limitations and shortcomings encountered by singular searching, while accommodates a new method for producing results from scale-down searches, thus retrieving additional information not present in the website description.

### OBJECTS AND ADVANTAGES

A primary objective inherent in the above described method and system of use is to provide a searching and retrieving method not taught by the prior arts and further advantages and objectives not taught by the prior art. Accordingly, several objects and advantages of the invention are:

Another objective is to retrieve information contained inside the website's database;

Another objective is to offer a more compelling and powerful search engine;

Another objective is to improve the quality of live of the client's by permitting them to use less time to find answers to their queries;

Another objective is to improve the searching experience;

A further objective is to reduce to the time the Internet is used to find data;

Other features and advantages of the described methods of use will become apparent from the following more detailed description, taken in conjunction with the accompanying drawings, which illustrate, by way of example, the principles of the presently described apparatus and method of its use.

### BRIEF DESCRIPTION OF THE DRAWINGS

The accompanying drawings illustrate at least one of the best mode embodiments of the present method of use. In such drawings:

FIG. 1 is a perspective general view of the main steps of inventive method system;

FIG. 2 is a detailed view of an exemplary systems used in the inventive method;

FIG. 3 illustrates a sample of a retrieving operation;

FIG. 4 is a view of last step of the inventive method;

### DETAILED DESCRIPTION

The above described drawing figures illustrate the described method and system of use in at least one of its preferred, best mode embodiment, which is further defined in detail in the following description. Those having ordinary skill in the art may be able to make alterations and modifications what is described herein without departing from its spirit and scope. Therefore, it must be understood that what is illustrated is set forth only for the purposes of example and that it should not be taken as a limitation in the scope of the present system and method of use.

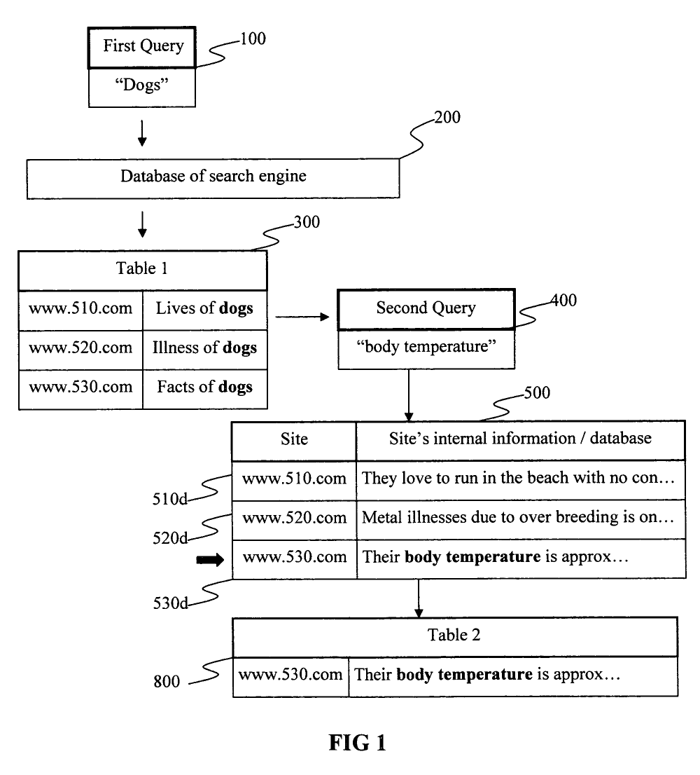

When a query is issued in a search engine, the search engine implements its database containing the information (primarily the description and the link to the website) on each of the websites present in the Internet to find the match to the query. With this in mind, let us proceed to FIG. 1, which illustrates a perspective view of a basic method and system of the invention. When the query 100 (FIG. 1) such as “dogs” is requested, the database 200 (FIG. 1) of the search engine is used to find the results shown in table 1 300 (FIG. 1). From Table 1 it can be appreciated that the search result includes 3 websites. Now the client produces a second query 400 (FIG. 1) such as “body temperature”. The purpose of this second query (“body temperature”) is to find internal data within each of the sites in Table 1. The search engine (and/or other program) then goes to each of the sites and provides the data of the second query (“body temperature”) to each and every one of the search engines present in each website. In this manner, the search engine of each website is utilized to find the results from the second query. In FIG. 1, further illustrates the internal information 500 (FIG. 1) each of the sites has within. In fact, the site www.530.com contains in its database 530d (FIG. 1) the text matching the second query 400 (FIG. 1). As a result, a second table is generated and displayed to the client providing the results depicted in table 2 800 (FIG. 1).

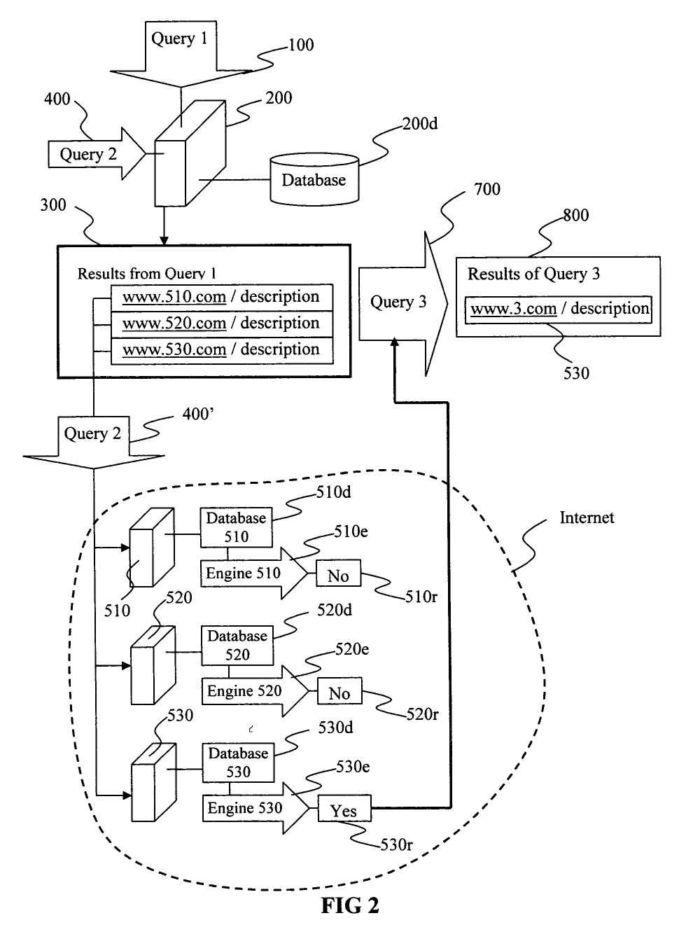

FIG. 2 illustrates in more detail most of the systems involved in the inventive method. A Query1 100 (FIG. 2) is requested. The server 200 (FIG. 2) searches for matching information in its database 200d (FIG. 2), which upon finding results generates the table named “results of Query1” 300 (FIG. 2) containing the matching sites. Then the client introduces a second query inquiring to search data within the resulting sites of the table “results of Query 1” 300 (FIG. 2). In response to such a request, the server 200 (FIG. 2) or any other program/system uses the data of the “results from Query1” 300 (FIG. 2) and visits each and every site thereto. The data of the second query or Query2 400 (FIG. 2) is transmitted to each of the respective website servers 510 (FIG. 2), 520 (FIG. 2), and 530 (FIG. 2); wherein their respective search engines 510e (FIG. 2), 520e (FIG. 2) and 530e (FIG. 2) received the data (from Query2). In the case of the website www.510.com, its respective server 510 (FIG. 2) uses its own search engine 510e (FIG. 2) to search its own database 510d (FIG. 2) to hopefully produce some results. Unfortunately for www.510.com, its search engine 510e (FIG. 2) produces no results 510r (FIG. 2). In the case of the website www.530.com, the server 530 (FIG. 2) using its search engine 530e (FIG. 2) does find matching results to the data from Query2 400′ (FIG. 2) present in its database 530d (FIG. 2); thus producing a positive result 530r (FIG. 2). In other words, the text of Query2 is found within the available databases to the site's search engine. The positive result 530r (FIG. 2) is then identified by the primary server 200 (FIG. 2) which utilizes it for generating a second table 800 (FIG. 2) with the results. The client can then click on the remaining table of results 800 (FIG. 2); thus narrowing the number of sites that must be visited or reviewed.

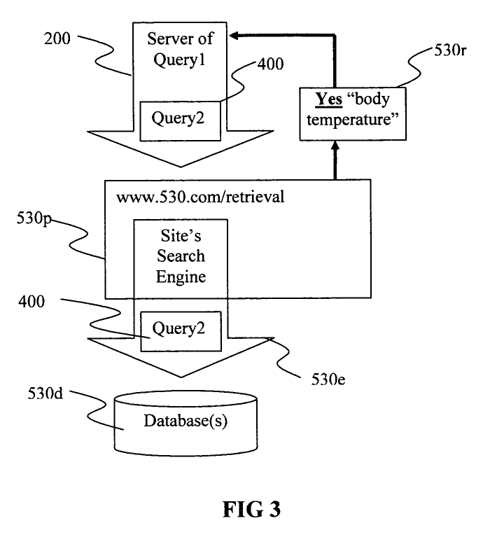

The next figure illustrates an example how an Internet search engine (or other) communicates with the search engine of a given site. In FIG. 3, the server (or program/others) of a first search 200 (FIG. 3) using the internet enters an extension file 530p (FIG. 3) which in this sample is a page on the target website (www.530.com). The Query2 400 (FIG. 3) is then executed implementing the websites search engine 530e (FIG. 3) which looks for the information in the websites database 530d (FIG. 3). In the case of this example, the search whitin the site turns positive 530r (FIG. 3). Basically any pre-designated html can be used to inform of the positive result 530r (FIG. 3).

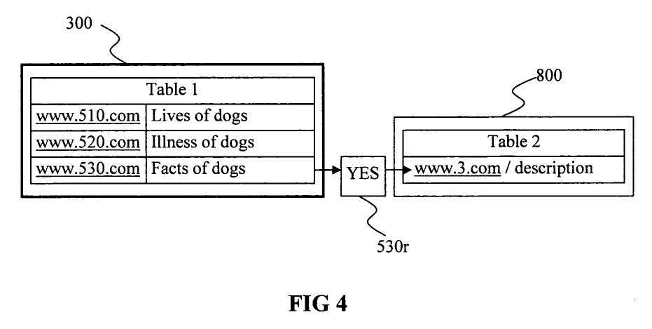

The final step of the method is to produce a table of results containing only those sites which server responded with a positive answer. FIG. 4 depicts the last step of the inventive method and system; wherein the table 1 300 (FIG. 4) is search, distilled, matched, etc implementing the site server's response 530r (FIG. 4) for producing a second table 2 800 (FIG. 4).

Another important aspect of the disclosed inventive method is the page, site extension or program the first search engine must use in order to access the particular website(s). As a result, in order to access information within the website(s), the website must contain a program, page and/or extension wherein a site's search engine can identify the querying data delivered by the first search engine. Thus, the site's search engine can received the data to execute and then look for the information within the site's database.

Noteworthy, when the first or retrieving search engine visits a site, there is an important need to establish three basic operating environment things:

a) The time parameter or how long the retrieving search engine (first engine) waits for a response from the search engine of the website. A good estimate may be 2 seconds. If no answer is received (positive) within the mentioned time frame, then the site is disconnected, without given a possibility to the site to respond later. Although this is an optional operation, it is needed since many factors can contribute to hold information indefinitely without a real or good purpose.

b) The type of response. Sites which do not find the query2 in their systems may or may not produce a negative answer. By producing a negative answers allows the search engine to exit (drop the signal) and continue asking other sites. However, if every search engine of every website needs to produce a response whether is a positive result (found data) or a negative result (found no data); the amount on transferring information could be large. Yet it is still possible to implement the acknowledgement of a finding utilizing one response for a particular finding of choice. For example, only the websites with a positive result (found the data from query 2) will respond, thus non-responding sites imply that no results were obtained or found; therefore only one signal is used for such type of notification.

c) The number of sites the retrieving search engine can access per request. To do this let us view what actually occurs when a client uses a search engine to visit the found results. The client is presented with a list of matching first query sites. Then the client clicks only one link to one of the sites. The client has to manually find the site's search engine which may be located in no particular place, thus increasing the site searching time and therefore internet time. Then the client proceeds in his search to another site and basically the operation is repeated until the client gets exhausted and/or finds sufficient information to fulfill his needs. This repetitive operation can indeed take a long time and therefore implement a lot of Internet time. The inventive method can perform the search in equal manner a lot faster than any human client, thus reducing the Internet time usage. The question now relays in how many sites will be searched for the second query. A good estimate is probably only 20 sites per retrieving operation, wherein the client has the possibility of performing a maximum total of 4 retrieving operations; which actually translates to a total of 80 websites. Although the number of sites that are to be retrieved can be further selected by the client before the retrieving operation is executed, it is true that if a client is given the freedom to use the described retrieving method at its own leisure, the possibilities of abusing the system are very likely; which is why a maximum of retrieving sites per operation and number of operations must be enforced.

The enablements described in detail above are considered novel over the prior art of record and are considered critical to the operation of at least one aspect of the apparatus and its method of use and to the achievement of the above described objectives. The words used in this specification to describe the instant embodiments are to be understood not only in the sense of their commonly defined meanings, but to include by special definition in this specification: structure, material or acts beyond the scope of the commonly defined meanings. Thus if an element can be understood in the context of this specification as including more than one meaning, then its use must be understood as being generic to all possible meanings supported by the specification and by the word or words describing the element.

The definitions of the words or drawing elements described herein are meant to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements described and its various embodiments or that a single element may be substituted for two or more elements in a claim.

Changes from the claimed subject matter as viewed by a person with ordinary skill in the art, now known or later devised, are expressly contemplated as being equivalents within the scope intended and its various embodiments. Therefore, obvious substitutions now or later known to one with ordinary skill in the art are defined to be within the scope of the defined elements. This disclosure is thus meant to be understood to include what is specifically illustrated and described above, what is conceptually equivalent, what can be obviously substituted, and also what incorporates the essential ideas.

The scope of this description is to be interpreted only in conjunction with the appended claims and it is made clear, here, that each named inventor believes that the claimed subject matter is what is intended to be patented.

### CONCLUSION

From the foregoing, a novel method of searching and retrieving of information can be appreciated. The described method overcomes the need for a client to visit each of the sites resulting from a first query in search for a second query within each of the resulting sites. Thus saving time to clients and reducing Internet communicating signals.

1. A method for identifying a subscribing member of a search engine, comprising the steps of:
a) Implementing an information for identifying a subscription of a member of the search engine;
b) Performing a search;
c) Providing a subscribing member resulting from said search;
d) Providing said information identifying said subscription of the subscribing member from said search.

2. The method of claim 1, wherein step (d) comprises grouping said subscribing members.

3. A method fro retrieving information, comprising the steps of:
a) Implementing a search engine for searching a first field of search;
b) Producing a result from said first search;
c) Identifying a querying information for searching a second field of search of said result;
d) Providing said querying information to a second search engine for searching said second field of search;
e) Identifying an information from said second search engine, and;
f) Implementing said information for searching said result from said first search.
